(19) United States
(12) Patent Application Publication
(10) Pub. No.: US 2008/0119181 A1
(43) Pub. Date: May 22, 2008

(54) RADIO BASE STATION, RADIO COMMUNICATION TERMINAL AND RADIO COMMUNICATION SYSTEM

(76) Inventors: Tomohito Suzuki, Yokohama (JP); Akihiko Yoshida, Yokohama (JP); Toshiyuki Saito, Kokubunji (JP); Shiro Mazawa, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/839,587

(22) Filed: Aug. 16, 2007

(30) Foreign Application Priority Data
Aug. 18, 2006 (JP) 2006-222880
Aug. 8, 2007 (JP) 2007-206046

(51) Int. Cl. H04Q 7/20; H04B 1/38; H04M 1/00

(52) U.S. Cl. 455/422.1; 455/561; 455/550.1

(57) ABSTRACT

A radio base station, a radio communication terminal, and a radio communication system that can efficiently utilize broadband resources even if many packets of different sizes and different QoS requirements are mixed when sent and received. When a data transmission request is sent from a radio terminal to a base station, at least one of a data transmission duration time, a transmission data transmission interval, and an expiration time is included in the data transmission request. The base station receives data transmission requests from multiple radio terminals, schedules the data transmission requests from multiple radio terminals, assigns bandwidths to the multiple radio terminals based on the duration time, transmission interval, and expiration time included in each of the data transmission requests and continues the assignment of bandwidths to the radio terminals during the duration time based on the received duration time.

### INCORPORATION BY REFERENCE

The present application claims priorities from Japanese applications JP2006-222880 filed on Aug. 18, 2006 and JP2007-206046 filed on Aug. 8, 2007, the contents of which are hereby incorporated by reference into this application.

### BACKGROUND OF THE INVENTION

The present invention relates to a communication control method for use in a radio base station, a radio terminal, and a radio communication system, and more particularly to a communication control method for use in a radio base station, a radio terminal, and a radio communication system that allows the base station to control communication from the radio terminals to the base station based on requests from multiple radio terminals in a high-speed, broadband radio communication network.

Widespread use of ADSL (Asymmetric Digital Subscriber Line) and optical communication networks in a wired communication makes speedy, broadband Internet access possible. On the other hand, widespread use of the Internet in radio communication also increases the need for high-speed web access and data communication, including music and video, and the intensive study of speedy, broadband access is now underway.

In radio communication, communication with the reverse link (uplink) speed of 154 kbps and the forward link (downlink) speed of 2.4 Mbps is implemented in the current 1×EV-DO to allow various types of data to be sent and received with the need for controlling the transmission of data of various packet sizes.

For use in such a variable-rate packet radio communication system, a technology such as the one disclosed in JP-A-2000-217159 is proposed for controlling the concentration of access in the reverse link channel. JP-A-2000-217159 proposes a method that, when a large amount of continuous data is sent in the reverse link channel from a mobile station to a base station, a usage request for a data size and the maximum rate is issued to the base station in advance for performing the optimum transmission with the transmission rate variable within the maximum rate specified by the base station.

### SUMMARY OF THE INVENTION

Communication with the reverse link speed of 154 kbps and the forward link speed of 2.4 Mbps is implemented in the current 1×EV-DO as described in the background technology and, in 1×EV-DO Rev.A that will be introduced in future, communication with the higher reverse link speed of 1.8 Mbps and the higher forward link speed of 3.1 Mbps will become possible. In this 1×EV-DO Rev.A, the services such as multicasting and the quality control (QoS: Quality of Service) of suppressing delays in packet communication can be provided.

In 1×EV-DO Rev.B, the study is now underway to implement communication with the reverse link speed of 27 Mbps and the forward link speed of 73.5 Mbps and, in addition, the study is already started for implementing a system with the maximum reverse link speed of 100 Mbps and the maximum forward link speed of 250 Mbps as the next-generation system for providing more speedy, broader band communication.

Such a rapid trend toward high-speed, broadband communication allows a larger amount of data to be sent and received and, at the same time, diversifies the services that create a need for transmitting data of various types and various packet sizes. This transmission need requires a communication control for flexibly processing a wide range of services provided by a new system and for fully utilizing the broadband resources.

From this point of view, the technology disclosed in JP-A-2000-217159 lacks information on QoS because it is designed in such a way that the size of data accumulated in the buffer and the maximum rate transmittable by a terminal are sent to the base station in advance for requesting the radio resources. Therefore, when many packets with different packet sizes and different QoS requirements are mixed within a user and are sent and received between users, the technology described in JP-A-2000-217159, if used alone, cannot perform a control operation that efficiently uses the resources prepared for broadband communication according to the different packet sizes and QoS requirements. When the control operation is not performed according to the QoS requirements, the granularity of scheduling in the base station for the reverse link radio resources in a user or between users becomes coarse. In addition, there is a possibility of inefficient scheduling, that is, the base station assigns resources wastefully, for example, assigns resources to data whose transmission time is already expired on the terminal side or, conversely, the base station does not assign necessary resources.

To solve the problems described above, it is an object of the present invention to provide a communication control method for use in a radio base station, a radio terminal, and a radio communication system that can efficiently use the resources prepared for broadband communication according to different packet sizes and QoS requirements even if many packets having different packet sizes and QoS requirements are mixed in a user and are sent and received between users.

To solve the problems described above, the present invention provides a radio terminal that sends a data transmission request, which includes information on data to be sent, to a base station; and a base station that receives the data transmission request from the radio terminal. Based on the information on data to be sent included in each data transmission request, the base station schedules the data transmission requests from multiple radio terminals and assigns bandwidths to multiple radio terminals and, at the same time, calculates a time required for data transmission from each radio terminal based on the information on the transmission data and continues the assignment of a bandwidth to the radio terminal for the calculated time.

When a radio terminal sends a data transmission request to a base station, the radio terminal includes information on the duration time of data transmission in the data transmission request, and the base station receives data transmission requests from multiple radio terminals. Based on a duration time included in each data transmission request, the base station schedules the data transmission requests from multiple radio terminals and assigns bandwidths to multiple radio terminals and, at the same time, continues the assignment of the bandwidth to each radio terminal for the duration time based on the received duration time.

The present invention provides a communication control method for use in a radio base station, a radio terminal, and a radio communication system that can efficiently use the resources prepared for broadband communication according to different packet sizes and QoS requirements even if many packets having different packet sizes and QoS requirements are mixed in a user and are sent and received between users.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the general configuration of a communication network that includes a radio communication system to which the present invention is applied, the Internet, and a wired communication system.

FIG. 2 is a diagram showing the hardware configuration of a radio terminal in one embodiment of the present invention.

FIG. 3 is a diagram showing the software-implemented functional blocks of a radio terminal.

FIG. 4A is a flowchart showing processing in a radio terminal for generating a request signal to be sent to a base station in the prior art.

FIG. 4B is a flowchart showing processing in a radio terminal for generating a request signal to be sent to a base station in first and third embodiments of the present invention.

FIG. 4C is a flowchart showing processing in a radio terminal for generating a request signal to be sent to a base station in a second embodiment of the present invention.

FIG. 5 is a diagram showing the hardware configuration of a base station in one embodiment of the present invention.

FIG. 6 is a diagram showing the software-implemented functional blocks of the base station.

FIG. 7A is a flowchart showing an algorithm used by a base station for processing request signals received from multiple radio terminals in the prior art.

FIG. 7B is a flowchart showing an algorithm used by a base station for processing request signals received from multiple radio terminals in the present invention.

FIG. 8A is a diagram showing an example of the message format of a request channel that is sent in the reverse link direction from a radio terminal to a base station in the first and second embodiments.

FIG. 8B is a diagram showing an example of the message format of a request channel that is sent in the reverse link direction from a radio terminal to a base station in the third embodiment.

FIG. 9 is a diagram showing an example of the message format of reverse link assign information that is sent from a base station to a radio terminal.

FIG. 10A is a sequence diagram showing the content of communication between multiple terminals and a base station in the prior art.

FIG. 10B is a sequence diagram showing the content of communication between multiple terminals and a base station in one embodiment of the present invention.

FIG. 11 is a diagram showing the structure of a super-frame applied to the present invention.

### DESCRIPTION OF THE EMBODIMENTS

The best mode for carrying out the present invention will be described with reference to multiple embodiments.

The description of the embodiments below is based on C.S0024-Rev.C for which development efforts are already started to implement it as a next generation system for higher speed and broader band communication.

Standardization studies are being carried out to make C.S0024-Rev.C a system that will be used in a phase two stages ahead of the current 1×EV-DO. In Rev.C, both reverse link and forward link communication is based on OFDMA (Orthogonal Frequency Division Multiple Access) with the reverse link speed of 100 Mbps and the forward link speed of 250 Mbps. The following describes some of the technical features of C.S0024-Rev.C used in the description of the embodiments of the present invention.

### [Super-Frame Structure]

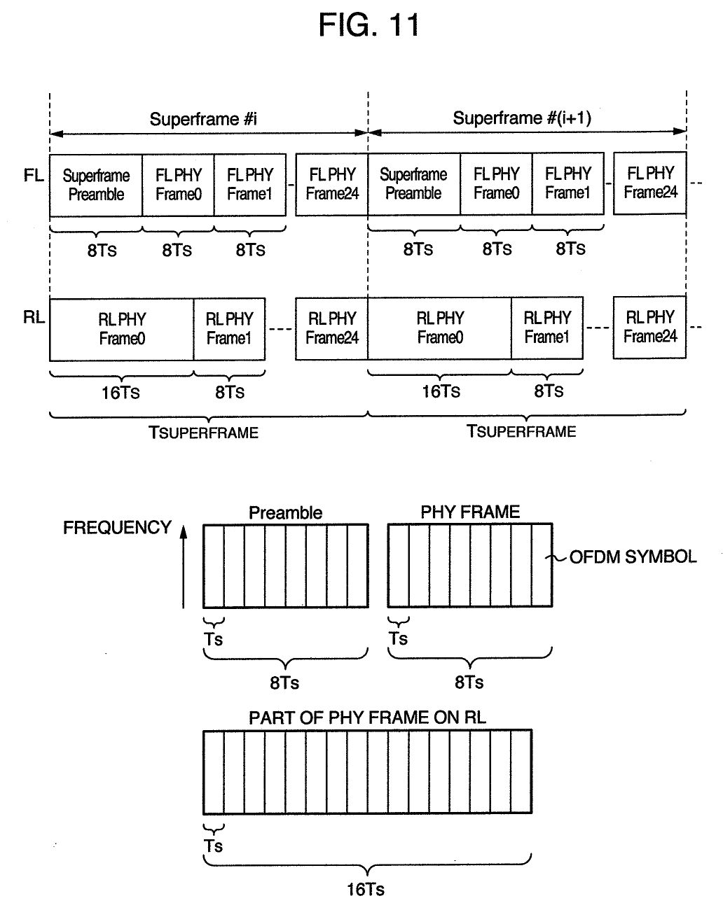

Transmission data and control information from a base station and a terminal are sent using frames called super-frames. FIG. 11 shows the structure of reverse-link/forward-link frames. On the forward link (FL: Forward Link) from a base station to a terminal, a super-frame is composed of a super-frame preamble and 25 PHY frames. The super-frame preamble includes the pilot signal for initial synchronization and the basic control information for identifying the terminal. A PHY frame, which is a data unit used in C.S0024-Rev.C, is composed of 8 OFDM symbols and each OFDM symbol is divided into sub-carriers with one tile size of 153.6 kHz×911.46 us. The 25 PHY frames are composed of forward a link common control channel and traffic channels. The forward link common channel includes control information such as traffic channel assignment information and power control for each reverse-link/forward-link user. The traffic channels include user data, and the maximum of one user is assigned per one tile from the tiles generated by dividing for each sub-carrier.

On the reverse link (RL: Reverse Link) from a terminal to a base station, a super frame is composed of 25 PHY frames. Because the super-frame preamble is not included on the reverse link, the first frame, PHY frame 0, is composed of 16 OFDM symbols to fill the time for the preamble on the forward link. Each of other PHY frames is composed of 8 OFDM symbols as in the forward link. An reverse link PHY frame includes user data and the reverse link control channel. The reverse link control channel will be described later. From the description above, the super-frame length T_{SUPERFRAME} is equal between the reverse link and the forward link as follows.

T_{SUPERFRAME}=8Ts×(1+25) (us)

### More specifically, the super-frame length is determined by the cyclic prefix length, and is 25.65, 27, 28.4, or 29.7 ms.

### [Transmission of R-REQCH (Reverse Request Channel)]

In C.S0024-Rev.C, the bandwidth assigned to the reverse link data communication, which is shared among multiple users (terminals), is assigned to multiple users (terminals) by the base station side. A terminal wishing to send data sends control information called an R-REQCH (Reverse Request Channel) from the terminal side to the base station to request the base station to assign resources. The R-REQCH includes information for scheduling the reverse link channel, and the base station schedules the reverse link channel based on the R-REQCH received from each terminal, sends the reverse link assign information, and assigns the resources.

In C.S0024-Rev.C, OFDMA is used for sending data. The R-REQCH can also be sent as an OFDM signal. The problem is that R-REQCHs, if issued randomly from many terminals to the base station, may cause interference among the terminals. To suppress this interference, the use of the CDMA system is being discussed to establish timing synchronization.

### [Types of Control Information]

In C.S0024-Rev.C, a terminal sends the following control information, including the R-REQCH described above, to a base station.

1. R-REQCH (Reverse Request Channel): Control information for sending information used to schedule a reverse link channel. This is sent for each packet that is sent. This control information includes the QoS of transmission data, the buffer size of transmission data, the maximum bandwidth requested by the terminal, and information on the reverse link sector.
2. MAC Header of Traffic CH: After a request is sent from a terminal to a base station using the R-REQCH described in 1 above and the reverse link assign information is received from the base station, this control information is sent as the header information on data when the data is sent to the assigned resources. This control information includes the transmission data buffer size information and the transmission data delay information (how long the transmission data has been stored in the queue of the terminal).
3. QoS Profile: This information is sent at the startup and shutdown of a QoS service when the QoS service is requested. This information includes QoS service type information.

C.S0024-Rev.C is a technology that is being studied for implementing a high-speed, broadband radio communication system for implementing the maximum reverse link speed of 100 Mbps and the maximum forward link speed of 250 Mbps. Implementing high-speed, broadband radio communication allows the diversified services to be provided with the result that many packets of different packet sizes and different QoS requirements are mixed on the Internet. In addition, it is expected that the small-sized, low-delay packet ratio will increase when VoIP (Voice over Internet Protocol) is widely used in 1×EV-DO Rev.A and later versions. So, there is a need for communication control that flexibly processes a wide range of services, which will be provided in future, and that fully utilizes the broadband resources.

In C.S0024-Rev.C, the reverse link channel scheduling information is sent from a terminal to a base station each time a packet is sent, as described above in [Types of control information]. That is, each time a packet is sent, the terminal sends the R-REQCH to the base station and receives reverse link assign information. The terminal side uses the radio resources, assigned by the base station, to send one packet. Therefore, when there are multiple packets to be sent from the terminal or when a sending packet is divided into multiple packets as a result of resource assignment before sending the packet, R-REQCHs must be sent, one for each packet. This increases the overhead of control information in relation to the whole radio resources, and the more power is consumed in the terminal as the number of times a sending request is issued is increased.

In the embodiments described below, a radio communication control technology will be described that flexibly processes a wide range of services, which will be provided in future, and that fully utilizes the broadband resources based on the technology being studied in C.S0024-Rev.C.

The following generally describes the embodiments. In a first embodiment, a radio base station receives a data transmission request from a radio terminal and, based on the QoS type of transmission data and so on included in the request, calculates a time required for data transmission. The base station schedules the data transmission requests from multiple radio terminals, assigns bandwidths to multiple radio terminals, and continues the assignment of the assigned bandwidth to each of the radio terminals for the calculated time. The transmission interval of a data transmission request on the terminal side is a fixed parameter determined uniquely from the QoS type and so on.

In a second embodiment, a radio terminal sends a data transmission request to the base station according to the environment change in the terminal side. This reduces the number of times the data transmission request is sent and improves the utilization of resources.

In a third embodiment, when a radio terminal sends a data transmission request to the base station, the radio terminal includes at least one of the transmission duration time, transmission interval, and expiration time of transmission data in the request. The base station receives data transmission requests from multiple radio terminals and, based on at least one of the transmission duration time, transmission interval, and expiration time of transmission data included in each data transmission request, determines an interval at which the terminal sends a data transmission request.

For example, for a service such as VoIP for which a predetermined amount of resources should be reserved, the proposed method is that a resource assignment request is not issued for each packet but a predetermined amount of resources is reserved when a first data transmission request is issued. The method for reserving a predetermined amount of resources is one of two methods; in one method, the agreement is made between a terminal and the radio base station that, if a new request is not received, the radio base station assigns reverse link resources continuously and, in the other method, a duration time parameter is added to a data transmission request, sent from the terminal, for specifying a duration time for which reverse link resources are assigned.

The expiration time of a data transmission request, if added to control information that is sent, allows the base station to set a period, during which the reverse link resource are scheduled, according to the received data transmission request. In addition, when it is desired to send small-sized packets at a fixed interval, for example, in VoIP, the addition of transmission interval information to the data transmission request does not reserve the resources continuously but allows the resource to be reserved at a fixed interval. The parameters described above may be used singly or in combination. A data transmission request is sent via OFDM or CDMA. When CDMA modulation is used, a data transmission request can be sent without establishing timing synchronization among multiple terminals by using the CDMA modulation only for sending a data transmission request.

### First Embodiment

First, the following describes the general configuration of a network that includes a radio communication system to which the present invention, described in a first embodiment to a third embodiment, is applied.

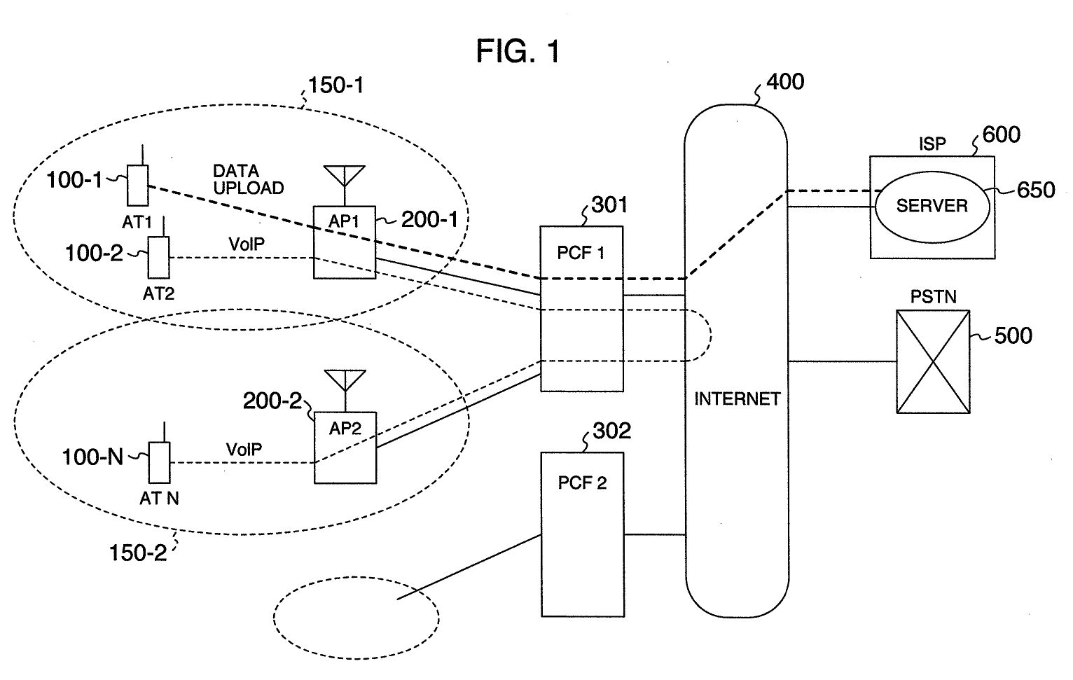

FIG. 1 is a diagram showing the general configuration a communication network that includes a radio communication system to which the present invention is applied, the Internet, and a wired communication system.

As shown in FIG. 1, the network in this embodiment comprises radio communication systems connected to the Internet and public switched telephone networks (PSTN) also connected to the Internet. In such a network, a terminal 100-1 of a radio communication system performs communication via a base station 200-1 in a reception area 150-1 and uploads a file to a server 650 in an Internet service provider (ISP) 600 on the Internet 400 via a packet control device (PCF: Packet Control Function) 301.

When voice data is sent from a terminal 100-2 to a terminal 100-N using VoIP (Voice over Internet Protocol), the voice data is sent to the base station 200-1 and, via the PCF that performs packet control and via the Internet, sent to a base station 200-2 and, after that, the voice data is sent to the terminal 100-N in a reception area 150-2 covered by the base station 200-2.

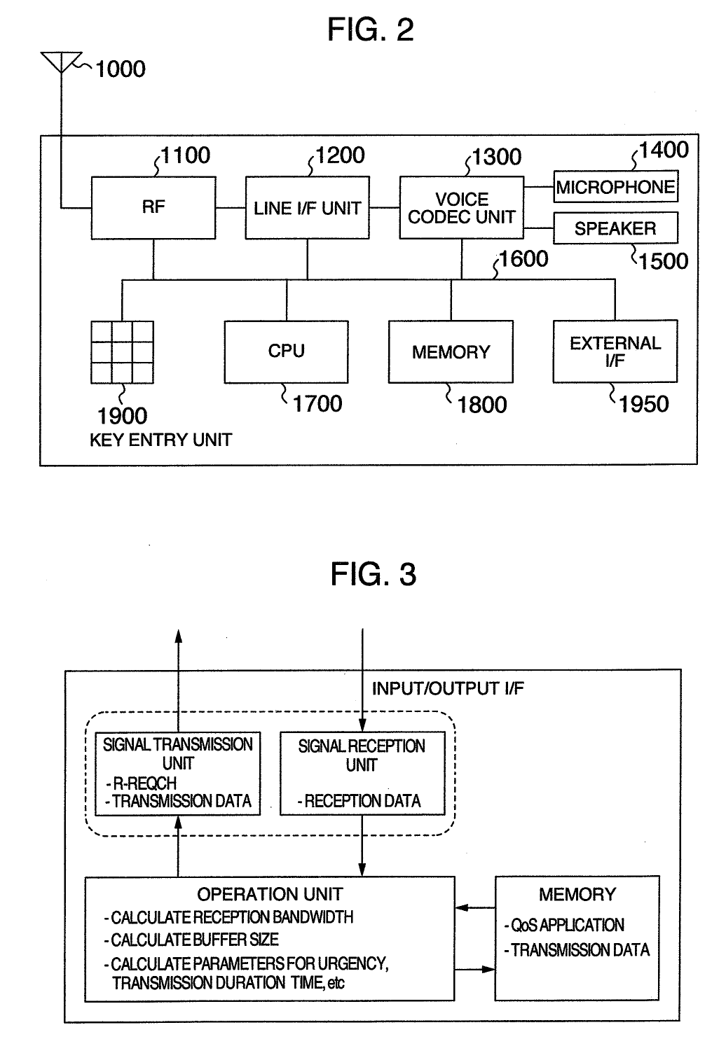

FIG. 2 is a diagram showing the hardware configuration of a radio terminal in one embodiment of the present invention.

As shown in FIG. 2, the terminal comprises an antenna (1000) that sends and receives radio waves to and from a base station and converts the radio waves to a high-frequency signal, an RF unit (1100) that modulates/demodulates the high-frequency signal and converts it to a low-frequency baseband signal, a line I/F unit (1200) that configures the frame of the baseband signal and converts it to a data signal, a voice codec unit (1300) that converts the data signal to a voice signal, a microphone (1400) that receives a voice and outputs it to the voice codec unit (1300) as an electric signal, a speaker (1500) that receives the electric signal of the voice from the voice codec unit (1300) and outputs it as a voice, a control bus (1600) used to control the functional blocks in the terminal, a control device (CPU)(1700) that has an operation unit for controlling the functional blocks and for generating R-REQCH parameters, a memory (1800), a ten-key pad (1900) used by an operator to connect and disconnect a voice call, and an external I/F (1950) such as a liquid crystal display. A codec unit for non-voice data is also provided as necessary.

FIG. 3 is a diagram showing the software-implemented functional blocks in the radio terminal.

A memory contains a QoS application supported by the terminal and data to be transmitted to a base station. An operation unit gets the QoS application and the transmission data from the memory and calculates the buffer size. In addition, the operation unit calculates the reception bandwidth of the terminal and sends the calculation result to an input/output I/F unit. The input/output I/F stores R-REQCH transmission parameters that are sent to a base station via the antenna of the terminal.

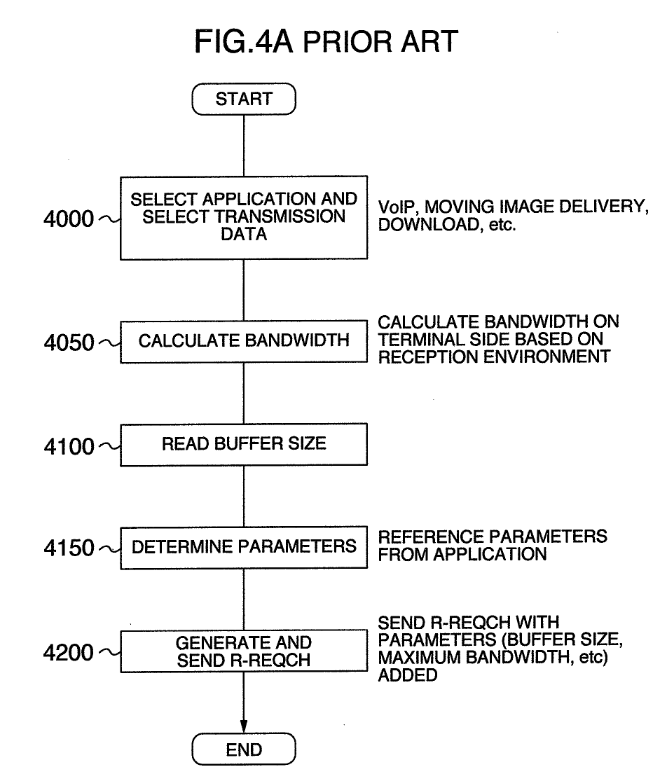

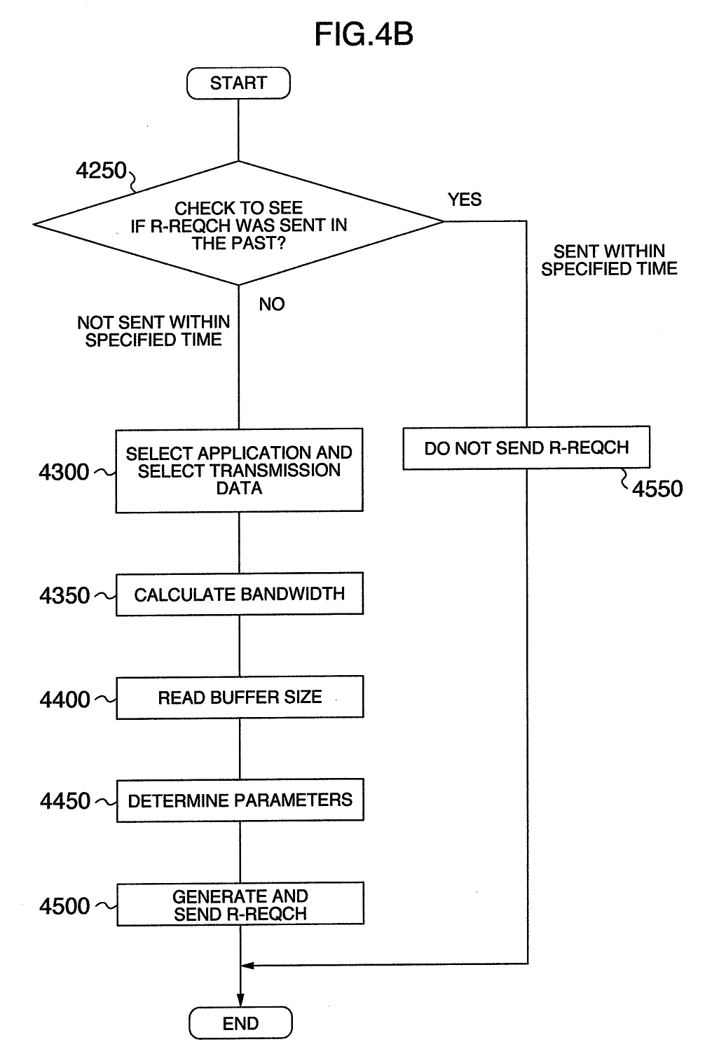

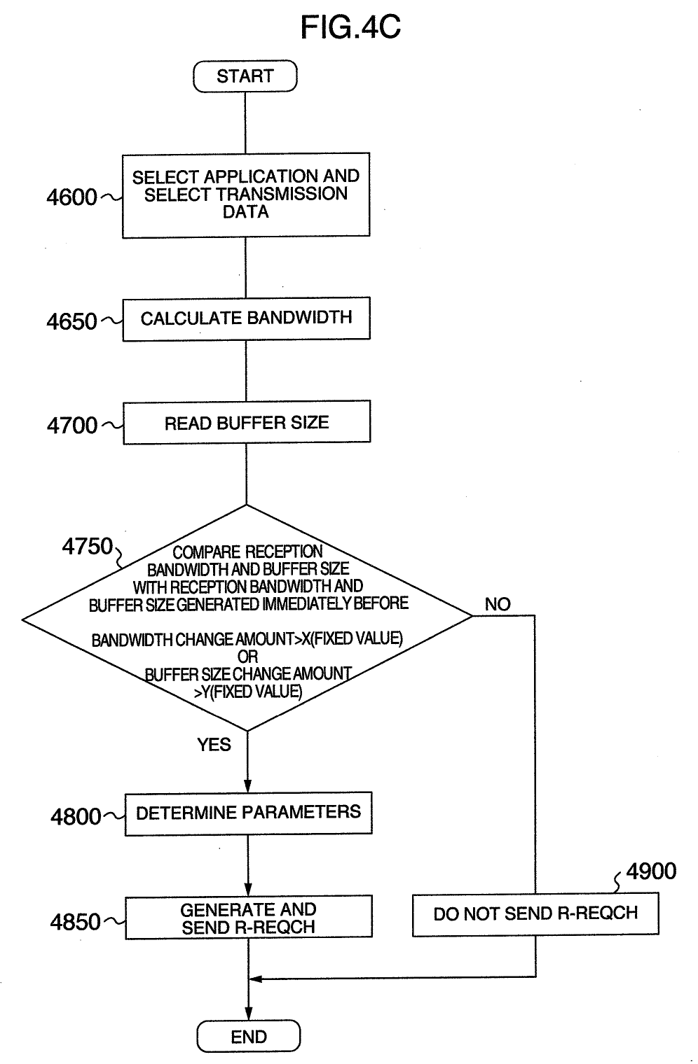

FIG. 4A is a flowchart showing the processing of the radio terminal in the existing system for generating the request signal to be sent to a base station.

First, the radio terminal selects the application to be started and the data to be sent by the selected application (4000). Next, the radio terminal calculates the bandwidth based on the reception environment of the terminal side (4050). Next, the radio terminal reads the buffer size of the transmission data (4100), specifies the parameters for the R-REQCH (4150), and sends a resource assignment request to the base station (4200).

FIG. 4B is a flowchart showing the processing for generating the request signal in this embodiment. First, the terminal side checks to see if the request signal was generated and sent to the base station on the terminal side within a specified time in the past (4250). The specified time is pre-set in the terminal and the base station as a fixed value determined uniquely based on the QoS type. If the request signal was sent within the specified time in the past, a new request signal need not be generated and so the processing is terminated (4550). If the request signal was not sent within the specified time, the terminal side generates the request signal. The generation flow is the same flow as that described in FIG. 4A.

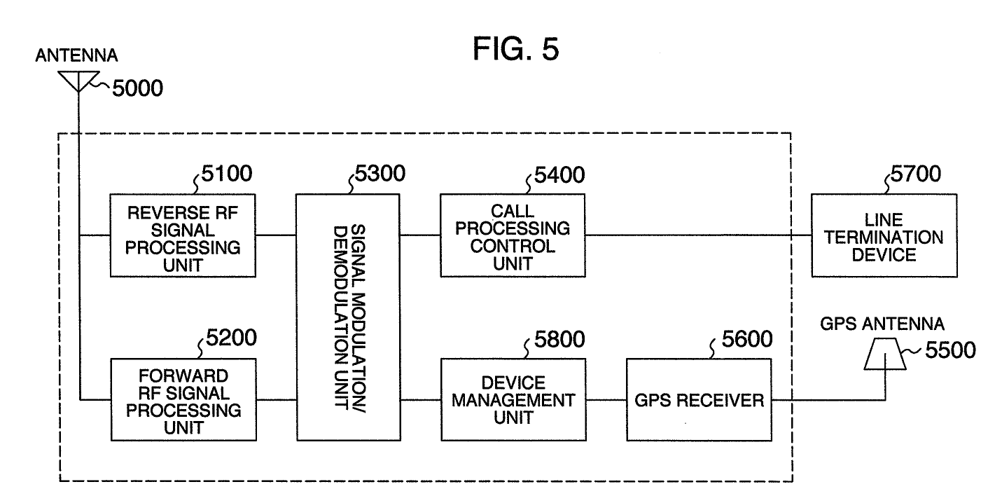

FIG. 5 is a diagram showing the hardware configuration of a base station in one embodiment of the present invention. The base station comprises an antenna (5000) that sends and receives radio signals to and from a terminal in the area covered by the base station, a reverse link signal processing unit (5100) that receives radio signals from a terminal and processes the signals, a forward link signal processing unit (5200) that sends signals to a terminal, a signal modulation/demodulation unit (5300) that performs scheduling processing for a transmission packet and establishes synchronization with reception signals, a device management unit (5400) that manages the whole device and connects to a maintenance terminal, a call processing control unit (5800) that generates the request signal according to the present invention, a GPS antenna (5500) that receives the GPS signal when the GPS signal is used as an example of time synchronization means, and a GPS receiver (5600) that generates time information based on the received GPS clock and supplies it into the device. The sent and received signals are sent to a line termination device (5700) that terminates the base station.

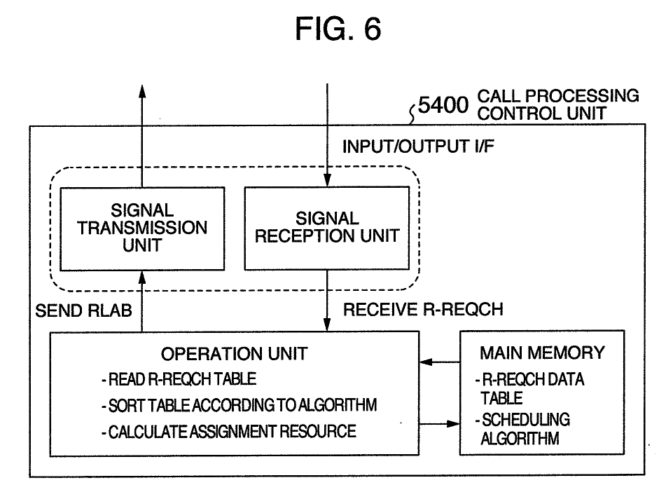

FIG. 6 is a diagram showing software-implemented functional blocks of the call processing control unit of the base station.

The call processing control unit receives the R-REQCH from a terminal in the area, covered by the base station, via an input/output I/F unit and sends the received R-REQCH to an operation unit. To assign resources to the received R-REQCH, the operation unit reads the R-REQCH data table and the scheduling algorithm from a main memory and sorts the table according to the algorithm that is read. Based on the sorted result, the call processing control unit calculates resources which will be assigned to the R-REQCH received from each terminal, sends the reverse link assign information from the signal transmission unit of the input/output I/F unit via the antenna of the base station, and assigns resources to each terminal.

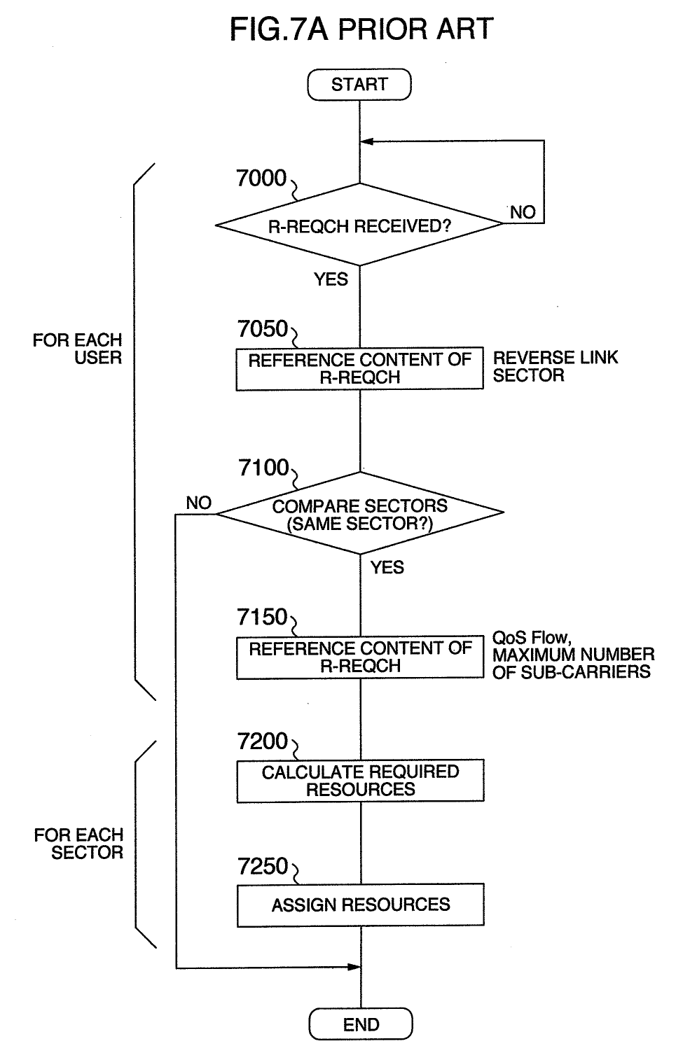

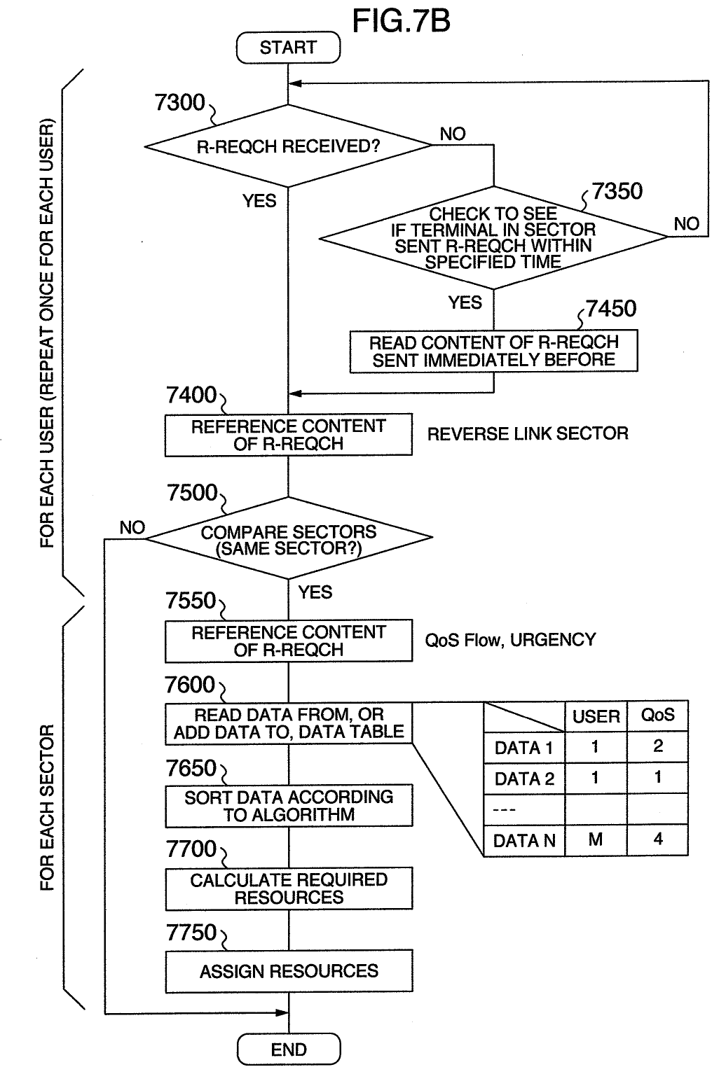

FIG. 7 is a flowchart showing the algorithm used by a base station for processing request signals received from multiple radio terminals.

First, the following describes an example in the prior art with reference to FIG. 7A. The base station checks if an R-REQCH is received from terminals in the area covered by the base station (7000) and, if an R-REQCH is received, references the content (7050). Next, the base station compares the terminals to see if they are in the same sector (7100) and, if so, continues the processing. Next, the base station references the R-REQCH parameters such as reverse link sector information, the maximum number of sub-carriers, QoS type, etc (7150). The flow to this step is performed repeatedly for multiple terminals which are in the covered area and from which R-REQCH is received. The subsequent flow is performed for each sector of each base station. After referencing the content of the R-REQCH, the base station calculates the required resources (7200). After calculating the resources, the base station assigns resources to each terminal (7250).

The following describes FIG. 7B that shows this embodiment. The base station checks if an R-REQCH is received from terminals in the covered area (7300) and, if an R-REQCH is received, references the content (7400). If an R-REQCH is not received, the base station checks to see if a terminal in a sector of the base station sent an R-REQCH within a specified time in the past (7350). If an R-REQCH was sent within a specified time, the base station reads the immediately preceding R-REQCH and references the content (7450). If an R-REQCH was not sent within a specified time, control is passed back to the R-REQCH reception confirmation flow (7300). This specified time is a fixed parameter determined uniquely based on the QoS type, and its value is stored in advance in the main memory in the terminal and the base station. Next, the base station compares if the terminals are in the same sector (7500) and, if so, continues the processing. Next, the base station references the R-REQCH parameters such as the reverse link information, maximum number of sub-carriers, and QoA type (7550). After referencing the content of the R-REQCH, the base station adds new data to the data table whose structure is that the sending user parameter and QoS type parameter are provided for each R-REQCH (7600). The base station sorts the data using the QoS type values (7650) and calculates the required resources (7700). At this time, the base station calculates the time for which the resources will be assigned based on the parameters included in the received R-REQCH. For example, if there is a correspondence between QoS types and data types, this is accomplished by specifying in advance the correspondence between QoS types and the time required for data transmission and storing the correspondence in a storage area in the signal modulation/demodulation unit. Rather than the QoS types, it is also possible to store the correspondence between the maximum number of sub-carriers included in the R-REQCH received from a radio terminal and the time required for data transmission. After calculating the resources, the base station assigns the resources to each terminal (7750). Unless the scheduling is changed, the assignment of resources to each terminal continues for the time the resources, calculated in step 7700, must be assigned.

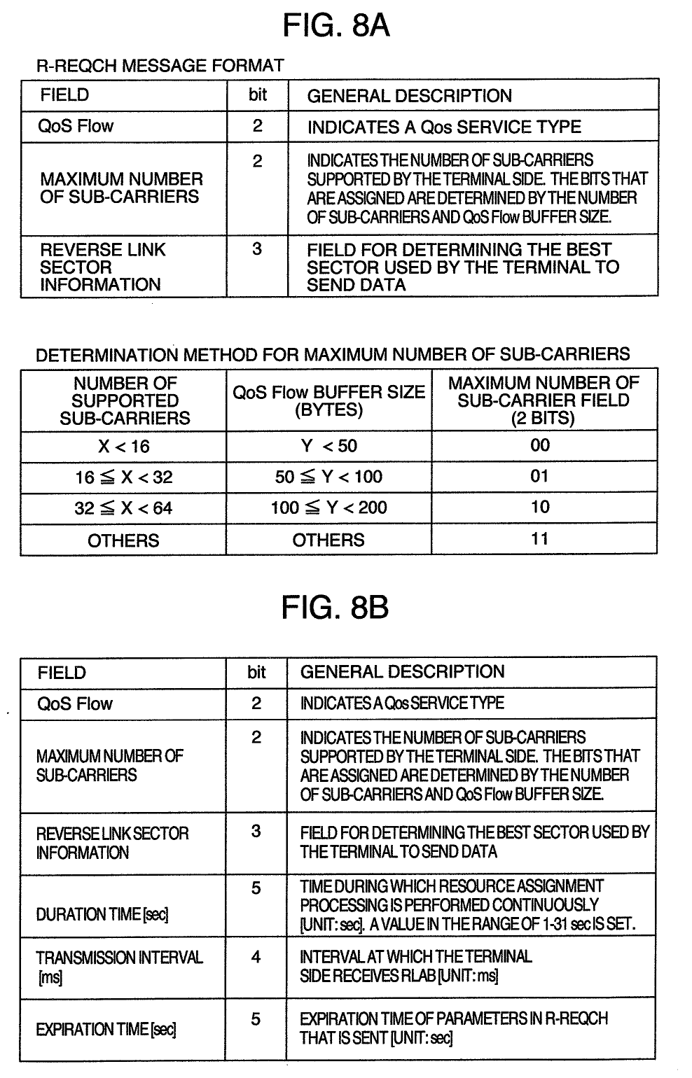

FIG. 8A shows an example of the message format of a request channel in the reverse link direction in which data is sent from a radio terminal to a base station.

FIG. 8A shows the message format of an R-REQCH used in this embodiment and the table used to determine the maximum number of sub-carriers.

FIG. 8A shows the content of information stored in each field, the number of bits assigned to the field, and the general description. QoS Flow, represented in 2 bits, indicates a QoS service type. QoS Maximum Number of Sub-Carriers, represented in 2 bits, indicates the number of sub-carriers supported by the terminal side. As shown in the table at the bottom of FIG. 8A, the bits assigned to the Maximum Number of Sub-Carriers field is determined by 2 bits according to the number of sub-carriers supported by the terminal and the QoS Flow buffer size. Reverse Link Sector Information is composed of the reverse link sector information for determining a sector.

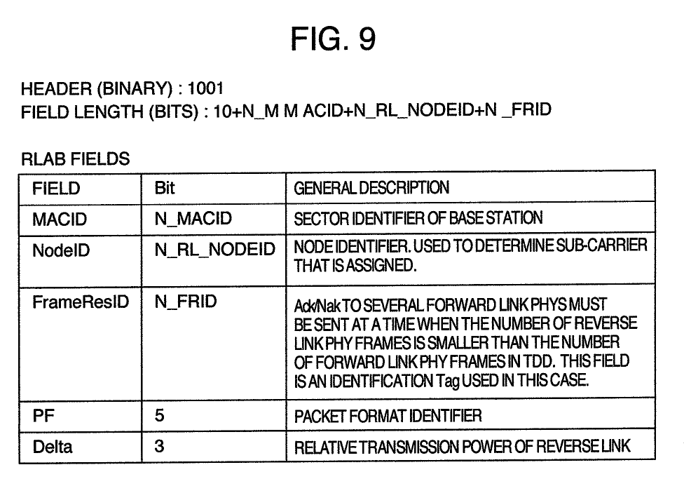

FIG. 9 shows an example of the message format of reverse link assign information that is sent from a base station to a radio terminal.

The figure shows the message format of an RLAB (Reverse Assignment Block) as an example of reverse link assign information used for resource assignment in this embodiment. The RLAB is composed of the node identifier (NodeID) that indicates a sub-carrier to be assigned, a packet format identifier (PF: Packet Format), and so on. The RLAB, included in the forward link control channel (F-SSCH: Forward-Shared Signaling Channel), is identified by the binary header.

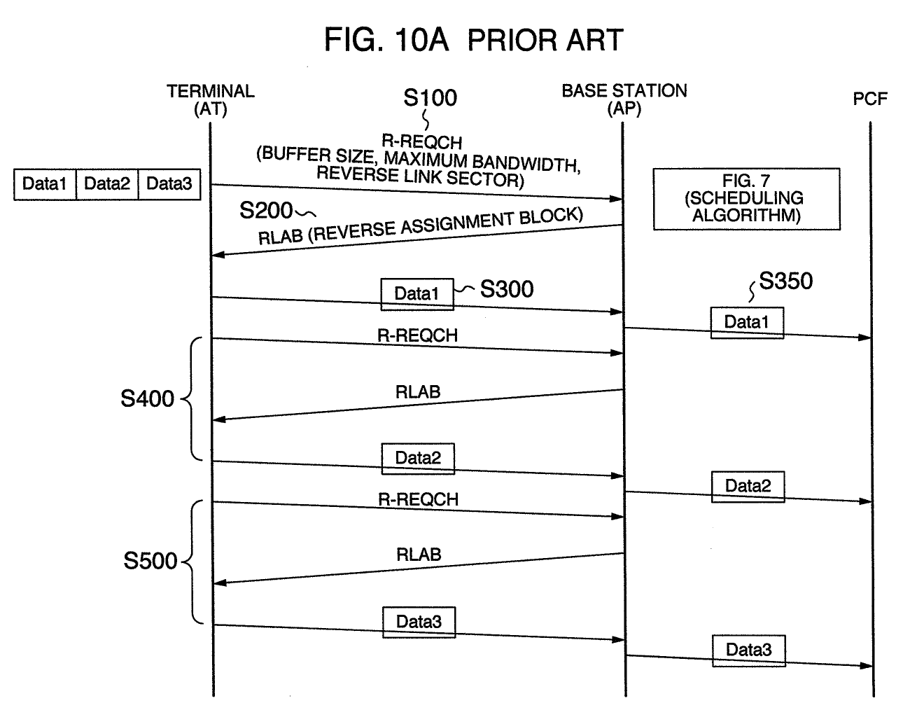

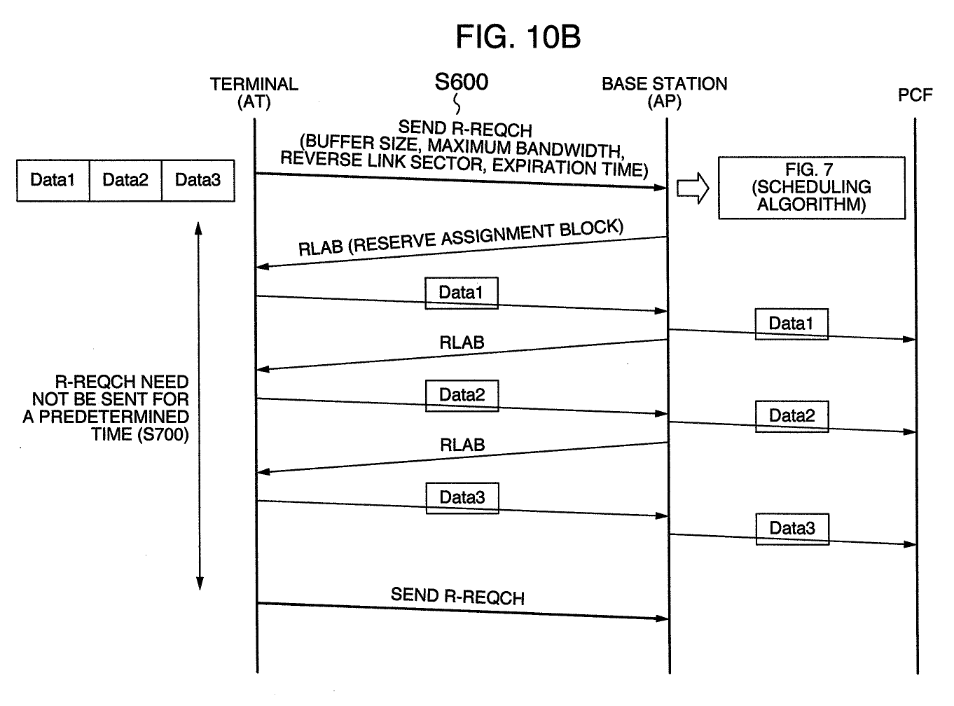

FIG. 10A and FIG. 10B show the sequence of R-REQCH transmission, resource assignment, and data transmission among a terminal, a base station, and a PCF used in the present invention.

FIG. 10A is a sequence diagram showing the content of communication between multiple terminals and a base station during the usual operation in C.S0024-Rev.C.

The terminal side sends an R-REQCH to the base station as the control information for starting communication (S100). The R-REQCH is sent using one PHY frame. The R-REQCH includes the parameters indicated by the message format in FIG. 8A described above. After receiving the R-REQCH, the base station sends the reverse link assign information and assigns the resources (S200).

The terminal that has received the reverse link assign information sends Data1 using the assigned resources (S300). Upon receiving Data1, the base station sends it to the Internet via the PCF for transmission to another terminal or a server (S350). If there is still data in the terminal side after sending Data1, the operations S100-S300 are repeated (S400, S500). Because there are Data2 and Data3 in the terminal in this sequence when the transmission of Data1 is completed, the R-REQCH is sent to send Data2. After the transmission of Data2 is completed, the R-REQCH is sent to send Data3 next.

FIG. 10B is a sequence diagram showing the content of communication between multiple terminals and a base station in one embodiment of the present invention.

The figure shows the sequence to which the present invention is applied. To start communication, the terminal side sends R-REQCH to request resource assignment (S600). R-REQCH must be sent each time the reverse link signal is sent in the prior art, while one R-REQCH is sent in this present invention to assign a fixed amount of resources to each terminal using the scheduling algorithm in FIG. 7 (S700). This method reduces the number of times the terminal side sends the R-REQCH and, instead, allows the terminal to send other data packets.

This embodiment is applicable to, and effective for, a mode of a service, such as VoIP and videophone, in which the communication rate is usually fixed and the resources must be assigned regularly and continuously.

### Second Embodiment

As an alternative to the method, described in FIG. 4 and FIG. 7 in the first embodiment, for determining the specified-time parameters indicating an interval at which an R-REQCH is sent from the terminal side, the following describes some methods for sending a new R-REQCH according to a terminal environment change. This method can increase the utilization of assigned resources. First, there is a method for sending an R-REQCH when the reception bandwidth of a terminal varies greatly. Because the bandwidth does not change greatly when the terminal is not moving at a high speed, there is no large change in the parameters included in the R-REQCH. In an environment where the parameter change amount is small, it is possible to reduce the number of times the R-REQCH is sent as compared with the method in which the R-REQCH is sent repeatedly. Second, there is a method for the terminal side to send an R-REQCH when the size of the buffer currently used for the communication changes greatly. An example is when the terminal side performs a handoff. Because the sending buffer size is increased at a handoff time to satisfy the need for notifying the parameters to the base station for performing the handoff, an R-REQCH is sent to request the reassignment of the buffer.

FIG. 4C shows a flowchart for describing the processing for generating the request signal in this embodiment. First, the radio terminal selects an application to be started and selects data to be sent using the selected application (4600). Next, the radio terminal calculates the bandwidth based on the reception environment of the terminal and reads the buffer size of the transmission data (4650, 4700). At this time, the radio terminal references the reception bandwidth value and the buffer size included in the R-REQCH generated immediately before and compares them with the calculated bandwidth and the buffer size (4750). The thresholds X and Y used for the determination are fixed values that are set previously in the terminal. At least one of the change amounts, if larger than the threshold, indicates that the terminal environment has changed. In this case, the radio terminal determines the parameters (4800) and issues a resource assignment request to the base station (4850).

One mode in which this embodiment is applied is when multiple QoSs are used at the same time. For example, when a communication operation such as web browsing or FTP is performed during VoIP or videophone communication, the communication buffer size is increased only during that operation. In this case, a possible method is to send a new resource assignment request.

### Third Embodiment

In the first embodiment described above, the specified-time parameter indicating an interval at which an R-REQCH is sent from the terminal side is a fixed parameter that is uniquely determined from the QoS type. In a third embodiment, a scheduling method will be described in which at least one of the bits indicating the transmission duration time of transmission data, the bits indicating the transmission interval of transmission data, and the bits indicating the expiration time of transmission data are added to, and transmitted with, an R-REQCH and in which the specified-time parameter is determined by the above-described parameters added to the R-REQCH.

The transmission duration time indicates a time during which a base station continuously assigns the resources in response to one R-REQCH received from a terminal. The transmission interval of an R-REQCH is a fixed parameter determined uniquely based on the QoS type in the first embodiment described above, while the transmission duration time parameter is defined in this embodiment to prepare multiple duration times according to the QoS types so that the duration time can be selected.

The transmission interval indicates an interval at which the terminal side wants to receive the reverse link assign information. This parameter is useful to receive reverse link assign information only at a time determined by a fixed interval in a case where the resources need not be assigned long and continuously because packets are sent at a fixed interval.

The expiration time is the expiration time of the request content (parameters) sent by the R-REQCH. When the expiration time is expired, the base station discards the information on the R-REQCH that has been managed and the terminal side issues a new resource assignment request using a new R-REQCH. Until the expiration time is expired, the R-REQCH is sent repeatedly at a fixed interval determined by the transmission duration time parameter or by the fixed value of the QoS.

FIG. 8B shows an example of the message format of a request channel in the reverse link direction from a radio terminal to a base station in the third embodiment.

FIG. 8B shows an example in which the information such as the duration time, transmission interval, and expiration time is sent to FIG. 8A. The figure shows an example of the names, the number of bits, and the layout of the fields.

Duration Time, represented in five bits, is information on the time, in seconds [s], during which the base station continuously assigns the resources. Transmission Interval is an interval, in milliseconds [ms], at which the terminal side receives the forward link assign signal. Expiration Time is a parameter specifying the expiration time, in seconds [s], of an R-REQCH that is sent. The correspondence between those parameters, that is, Duration Time, Transmission Interval, and Expiration Time, and the service and QoS types is set in the memory 1800 in advance, and the corresponding value is read, stored in the corresponding field of the R-REQCH, and transmitted.

The parameters are added by the terminal in 4300 in the flow in FIG. 4 where a reverse link request channel is generated. The following describes an example of the parameter setting method. The transmission duration time can be determined according to the terminal environment (bandwidth) and the buffer size. An efficient method is that the thresholds are set and the values are divided into fixed values based on the values of the reception bandwidth and the buffer size, as in the method for determining the maximum number of sub-carriers shown in FIGS. 8A-8B. In addition, when the reception bandwidth of a terminal is narrow, the frequency-domain resource assignment is not enough and, therefore, a large time domain must be assigned. The transmission interval is sometimes determined to be a fixed interval according to the QoS type and, in this case, a predetermined value may be set in advance in one embodiment. For the expiration time, one possible method is that a value is individually set according to the QoS type.

Next, the following describes a method for determining a specified-time, which indicates an interval at which an R-REQCH is transmitted, using the parameters described above. Because the transmission duration time indicates the time during which a resource assignment request is issued continuously to the base station, the specified-time can be determined according to the value of the transmission duration time.

The transmission interval, which is a parameter efficient for reserving the resources at a fixed interval, is determined by associating it with the QoS type. If the total size of data to be sent and the size of the buffer that can be sent by one communication operation are determined, the number of times the resource assignment is required is determined and, therefore, the specified-time for sending an R-REQCH can be found by accumulating the transmission interval and the number of times the resources are assigned.

For the expiration time, an efficient method is that an R-REQCH is sent again when the expiration time is expired and, as with the transmission duration time, the specified-time can be determined by the correspondence.

The following describes the effect of the embodiments of the present invention.

A method is defined between a terminal and a radio base station in such a way that the base station uses a predetermined method to calculate the transmission duration time, required to complete the transmission of data, according to the buffer size, data type, and data QoS of data to be transmitted by the terminal if a new request is not received. And, the base station assigns reverse link resources continuously to the terminal for the calculated duration time. Alternatively, a parameter indicating the transmission duration time required for sending the transmission data is added to a data transmission request that is sent from the terminal to the base station to notify the base station about the transmission duration time when the R-REQCH is sent. Any of the methods described above reduces the number of times the terminal sends the data transmission request and reduces the control information overhead with respect to the whole resources. Because the saved radio resources can be assigned to other data transmissions, the performance of the radio system improves.

The following describes the effect of an expiration time. An expiration time is set, included in an R-REQCH to be sent from a terminal to a base station, and sent from the terminal to the base station. It is possible to remove information not necessary to transmit any more, for example, voice data delayed longer than a predetermined time, from the scheduling in the base station. Because radio resources conventionally used to wastefully send data can be assigned to other data transmissions, the performance of the radio system improves.

The transmission interval is a parameter useful when small-sized packets are sent at a fixed interval. Adding transmission interval information to a reverse link resource request allows resources to be controlled in such a way that, when small-sized packets such as those for VoIP are sent at a fixed interval, the resources are reserved not continuously but at a fixed interval. Reserving radio resources continuously for data that is sent at an interval results in the radio resources being assigned even to a time zone in which the terminal has no data to send and, thus, the resources of the whole radio system are consumed wastefully. The transmission interval parameter allows resources to be assigned efficiently only in a time zone, in which the terminal has data to send, and allows wastefully reserved resources to be assigned to other resources, thus improving the performance of the radio system.

The parameters described above may be combined for use.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A radio base station that receives data transmission requests from a plurality of radio terminals and, based on information included in the data transmission requests, schedules the data transmission requests from said plurality of radio terminals and assigns bandwidths to said plurality of radio terminals, comprising:
a device management unit that determines a duration time of bandwidth assignment to each of the radio terminals based on information on transmission data, which is included in the data transmission request from said radio terminal, and continues the bandwidth assignment to the radio terminal for the duration time.

2. The radio base station according to claim 1 wherein
the information on transmission data is information on a Quality of Service (QoS) for suppressing a delay in the transmission data, a correspondence between the QoS information and a time required for data transmission is stored in a storage area in said device management unit in advance, and the duration time of bandwidth assignment to said radio terminal is determined by referencing the stored time required for data transmission.

3. The radio base station according to claim 1 wherein said radio base station receives a data transmission request, including information on the duration time of bandwidth assignment requested by said radio terminal, from said radio terminal and determines the duration time of bandwidth assignment to the said radio terminal based on the information on the duration time of bandwidth assignment requested by said radio terminal.

4. The radio base station according to claim 1 wherein said radio base station receives a data transmission request, including information on an expiration time of transmission data, from said radio terminal and, based on the information on an expiration time of the data, schedules the data transmission requests from said plurality of radio terminals and assigns the bandwidths to said plurality of terminals.

5. A radio communication terminal comprising at least an antenna that sends and receives radio waves to and from a base station; a transmission/reception signal processing unit that performs modulation/demodulation processing, framing processing, and encoding/decoding processing for high-frequency signals sent and received via said antenna; an external interface that receives transmission data and outputs reception data; a key entry unit; a memory; and a control unit that controls the units, wherein
when a data transmission request is sent to said base station, information on a transmission duration time of data to be sent is included in the data transmission request.

6. The radio communication terminal according to claim 5 wherein
when a data transmission request is sent to the base station, information on a transmission duration time of data to be sent or information on an expiration time of data to be sent is included in the data transmission request.

7. A radio communication system including a plurality of radio terminals and at least one base station wherein
each of said radio terminals comprises at least an antenna that sends and receives radio waves to and from a base station; a transmission/reception signal processing unit that performs modulation/demodulation processing, framing processing, and encoding/decoding processing for high-frequency signals sent and received via said antenna; an external interface that receives transmission data and outputs reception data; a key entry unit; a memory; and a control unit that controls the units,
when each of the radio terminals sends a data transmission request to said base station, the radio terminal includes information on transmission data in the data transmission request and
a device management unit of said base station receives data transmission requests from said plurality of radio terminals, schedules the data transmission requests from said plurality of radio terminals, assigns bandwidths to said plurality of radio terminals based on the information on transmission data included in each of the data transmission requests and continues the assignment of bandwidths to said plurality of radio terminals based on the information on transmission data.

8. The radio communication system according to claim 7 wherein
each of said radio terminals includes information on a duration time of data transmission in the data transmission request, and
a device management unit of said base station receives data transmission requests from said plurality of radio terminals, schedules the data transmission requests from said plurality of radio terminals and assigns bandwidths to said plurality of radio terminals based on the information on a duration time included in each of the data transmission requests and, at the same time, continues the assignment of bandwidths to said plurality of radio terminals during the duration time.

9. The radio communication system according to claim 7 wherein
when each of the radio terminals sends a data transmission request to said base station, the radio terminal includes at least one of a transmission interval and an expiration time of transmission data, and
a device management unit of a main device of said base station receives data transmission requests from said plurality of radio terminals and schedules the data transmission requests from said plurality of radio terminals and assigns bandwidths to said plurality of radio terminals based on at least one of the transmission interval and the expiration time of transmission data included in each of the data transmission requests.
